(19) United States
(12) Patent Application Publication
(10) Pub. No.: US 2010/0125459 A1
(43) Pub. Date: May 20, 2010

(54) STOCHASTIC PHONEME AND ACCENT GENERATION USING ACCENT CLASS

(75) Inventors: Nobuyasu Itoh, Yokohama-shi (JP); Tohru Nagano, Yokohama-Shi (JP); Masafumi Nishimura, Yokohama-Shi (JP); Ryuki Tachibana, Yokohama-Shi (JP)

Correspondence Address: WOLF GREENFIELD & SACKS, P.C., 600 ATLANTIC AVENUE, BOSTON, MA, 02210-2206, US

(73) Assignee: Nuance Communications, Inc., Burlington, MA (US)

(21) Appl. No.: 12/496,366

(22) Filed: Jul. 1, 2009

Related U.S. Application Data
(63) Continuation of application No. 12/273,130, filed on Nov. 18, 2008, now abandoned.

(51) Int. Cl. G10L 13/08; G10L 13/00

(52) U.S. Cl. 704/260; 704/266; 704/E13.011; 704/E13.001

(57) ABSTRACT

Exemplary embodiments provide for determining a sequence of words in a TTS system. An input text is analyzed using two models, a word n-gram model and an accent class n-gram model. A list of all possible words for each word in the input is generated for each model. Each word in each list for each model is given a score based on the probability that the word is the correct word in the sequence, based on the particular model. The two lists are combined and the two scores are combined for each word. A set of sequences of words are generated. Each sequence of words comprises a unique combination of an attribute and associated word for each word in the input. The combined score of each of word in the sequence of words is combined. A sequence of words having the highest score is selected and presented to a user.

### RELATED APPLICATION

This application is a continuation (CON) of U.S. application Ser. No. 12/273,130, entitled “STOCHASTIC PHONEME AND ACCENT GENERATION USING ACCENT CLASS,” filed on Nov. 18, 2008, which is herein incorporated by reference in its entirety.

### BACKGROUND OF THE INVENTION

1. Field of the Invention

The present invention relates generally to text-to-speech synthesis and more specifically to determining a sequence of words.

2. Description of the Related Art

The front-end modules of text-to-speech (TTS) systems assign linguistic and phonetic information to input plain texts, which is critical for creating intelligible and natural speech. For Japanese, the front-end process consists of five sub-processes, word segmentation, part-of-speech tagging, grapheme-to-phoneme conversion, pitch accent generation, and prosodic boundary detection.

### BRIEF SUMMARY OF THE INVENTION

According to one embodiment of the present invention, a sequence of words is determined. An input is received, wherein the input comprises an original set of characters, wherein each character in the original set of characters comprises a set of words. Each word in the set of words for each character in the original set of characters is analyzed using a first model. A first list of words for each word in the set of words for each character in the original set of characters is generated using the first model, wherein each word in the first list of words is a predicted word for a word in the set of words for each character in the original set of characters based on the first model. A first score is assigned to each word in the first list of words, wherein the first score is based upon a likelihood that the word is a correct word for a word in the set of words for each character in the original set of characters based on the first model. Each word in the set of words for each character in the original set of characters is analyzed using a second model. A second list of words for each word in the set of words for each character in the original set of characters is generated using the second model, wherein each word in the second list of words is a predicted word for a word in the set of words for each character in the original set of characters based on the second model. A second score is assigned to each word in the second list of words, wherein the second score is based upon a likelihood that the word is a correct word for a word in the set of words for each character in the original set of characters based on the second model. The first list of words for each word in the set of words for each character in the original set of characters is combined with the second list of words for each word in the set of words for each character in the original set of characters to form a set of ordered pairs for each word in the set of words for each character in the original set of characters. The first score and the second score are combined for each word in the set of ordered pairs for each word in the set of words for each character in the original set of characters to form a combined score for each word in the set of ordered pairs for each word in the set of words for each character in the original set of characters. A set of sequences of words is formed, wherein each sequence of words in the set of sequences of words represents a unique combination of an attribute and an associated word from the set of order pairs for each word in the set of words for each character in the original set of characters. A total score is calculated for each sequence of words in the set of sequences of words by adding the combined score for each word in the sequence of words. The sequence of words from the set of sequences of words having a highest total score is selected, forming a selected sequence of words. The selected sequence of words is presented to a user in the form of an audio, video, or tactile representation, or any combination thereof.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a system for determining a sequence of words in accordance with an exemplary embodiment; and

FIGS. 4A-4B show a flowchart illustrating the operation of determining a sequence of words according to an exemplary embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

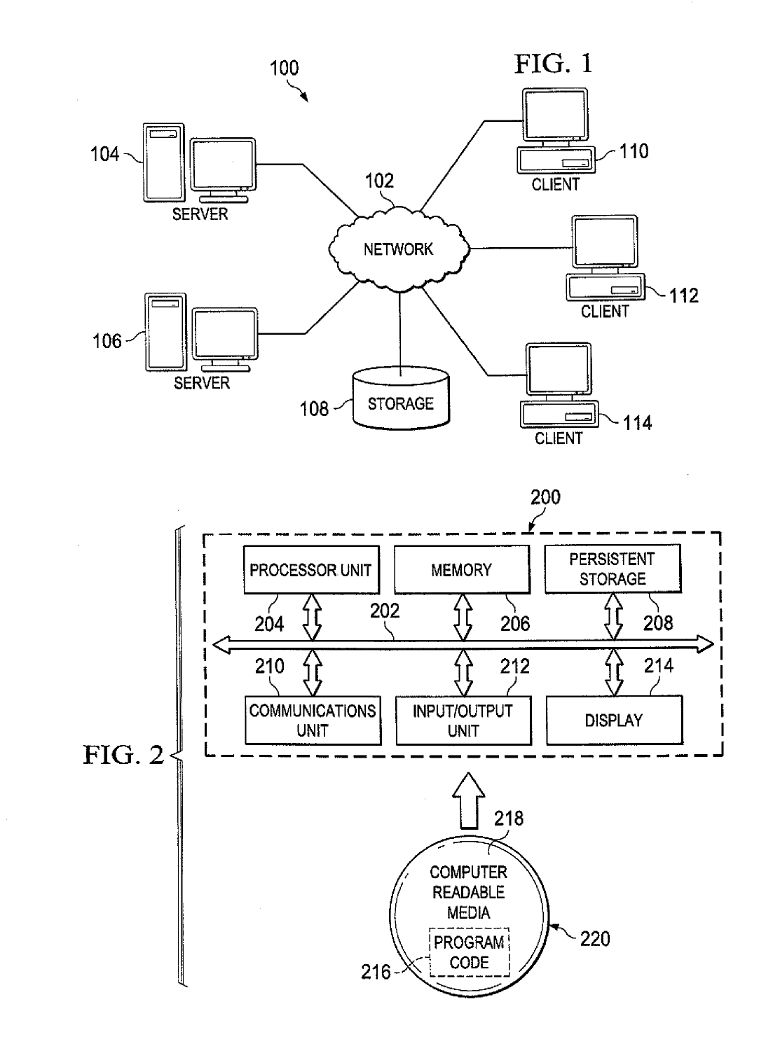

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

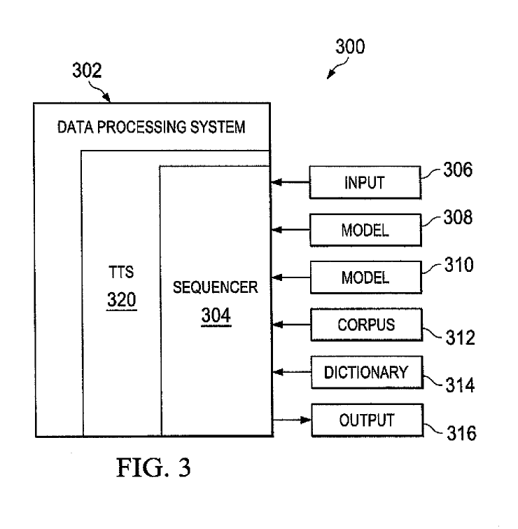

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer-implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

As the front-end process consists of five sub-processes, a common approach is for the front-end modules to use a TTS dictionary to perform the sub-processes. The TTS dictionary generally contains the spellings, the part-of-speech labels, the phonemes, and the base accents for each word. The base accent of a word is the accent that is used when the word is spoken in isolation. The accent can be changed by the context. An accent in a specific context is called a context accent. Hence, the base accent is merely one of the possible accents of the word. Since there are several possible combinations of phonemes and accents, choosing the correct combination for each word depending on the local context is a problem for the front-end modules.

Prior solutions have used a rule-based approach to handle pitch accent generation in Japanese. The rule-based approach determines the context accent for each word in the context by modifying the base accent of the word applying an appropriate rule chosen from a detailed rule set. A strong point of this method is that the types of pitch accents for words can be represented by a small number of rules. However, the maintenance of the rules and the dictionaries is time-consuming, since it is necessary to maintain the consistency of the rules while avoiding side effects. In addition, the maintenance of the rules and the dictionaries requires many exceptions to the rules.

Exemplary embodiments provide generating a sequence of words based on input. Exemplary embodiments simultaneously handle word segmentation, part-of-speech tagging, grapheme-to-phoneme conversion, and pitch accent generation when determining a sequence of words. Exemplary embodiments provide advantages including scalability and ease of domain adaptation compared with rule-based approaches.

According to an exemplary embodiment, when there is a word in the input sentence that is not in the training corpus, a dictionary is used to look up the phonemes and the accents of the word. However, the dictionary gives only the base accent, which can be different from the correct accent in that context. Exemplary embodiments improve the accuracy of the estimation of accents and phonemes by combining the word-based n-gram model and the accent class-based n-gram model.

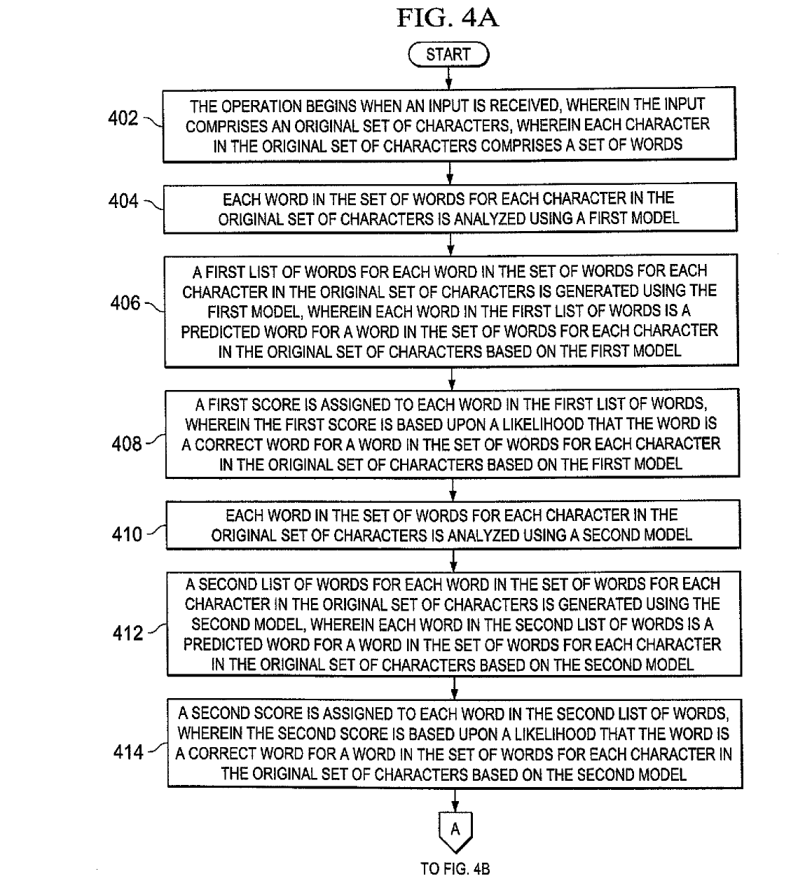

FIG. 3 is a block diagram of a system for determining a sequence of words in accordance with an exemplary embodiment. The system for determining a sequence of words is generally designated as 300. System 300 comprises data processing system 302, input 306, corpus 312, dictionary 314, models 308 and 310, and output 316. Data processing system 302 may be implemented as a data processing system such as data processing system 200 in FIG. 2. Data processing system 302 comprises TTS 320, which is a text-to-speech system. Sequencer 304 is a component of TTS 320. Sequencer 304 is a software component for determining a sequence of words.

Dictionary 314 is a TTS dictionary, which contains the spellings, the part-of-speech labels, the phonemes, and the base accents for each word in dictionary 314. Corpus 312 is a training corpus for TTS 320, which comprises a list of sentences. Each sentence consists of a list of words. A word is comprised of component parts including a spelling, a part-of-speech, phonemes, and accents. Models 308 and 310 are models used for determining a sequence of words. In an exemplary embodiment model 308 is a word n-gram model that is used for estimating next word from the history of words. A word n-gram model gives a word sequence that has maximum likelihood of being the correct sequence of words based on corpus 312.

In an exemplary embodiment, model 310 is an accent class n-gram model. A class n-gram model is used for estimating a next class that contains words with the same accentual feature from a history of accentual classes. Words with the same accentual feature are grouped into a class. This class can cover the vocabulary in the dictionary using the partial information of the word. Both for the in-corpus words and the dictionary words, assuming contextual accent changes, multiple copies of each word are generated with different context accents.

Input 306 comprises a set of characters. Each character comprises a set of words. The set of characters comprises one or more characters. The set of words comprises one or more words. A word is comprised of component parts including a spelling, a part-of-speech, phonemes, and accents. In an exemplary embodiment, input 306 is plain text. For example, input 306 may be comprised of Japanese kanji, which must then be converted to constitute individual words that comprise the kanji. Output 316 is the sequence or words selected by sequencer 304. Output 316 is presented to a back-end process, which is a waveform generation process. The waveform generation process generates waveforms using output 316. These generated waveforms are presented to a user as an audio, video, or tactile representation or any combination thereof of the selected sequence of words.

TTS 320 receives input 306. Sequencer 304 then refers to corpus 312, dictionary 314 and models 308 and 310 in analyzing input 306 in order to determine and generate output 316. Corpus 312, dictionary 314, model 308, model 310 and input 306 may all be resident on data processing system 302 or data processing system may retrieve various components from one or more external sources. Further, output 316 may be presented to a user through data processing system 302 or through a remote data processing system.

An accent class n-gram model predicts the contextual accent changes of words. Words with the same accentual feature are grouped into a class. Each word of both the in-corpus words and the dictionary words is grouped into a class. According to an exemplary embodiment, the grouping of words into classes comprises the steps of: (1) preparing an accent class for each combination of the accentual feature of the words in corpus 312 and dictionary 314; (2) each word of corpus 312 is grouped into a class according to the accentual feature of the word; (3) each word in dictionary 314, assuming the context accents are same as the base accents, is grouped into a class according to the accentual feature of the word; (4) for the words in both corpus 312 and dictionary 314, assuming contextual accent changes, multiple copies of each word are generated with different context accents and the generated copies are grouped into a class according to the accentual feature of the word; (5) the class uni-grams and bi-grams are counted using a word class map built by these procedures; and (6) the word probabilities are for each class and non-zero probabilities are assigned to the copied words.

Exemplary embodiments generate an output, output 316, for an input, input 306, comprising the sequence of words with the highest probability of being the correct sequence with the constraint that the concatenation of the spellings, w, of the sequence of words in the output is equal to the concatenation of the spellings of the sequence of words in the input x=x₁x₂ . . . xₗ=w:

û=argmax P(u₁u₂ . . . uₕ|x₁x₂ . . . xₗ), (1).

The probability of the word sequence in Equation (1) is calculated from the training corpus based on the word n-gram model:

$$Pu ( {u}_{1} {u}_{2} … {u}_{h} ) = {\sum }_{i = 1}^{h + 1} P ( {u}_{i} \vert {u}_{i - k} … {u}_{i - 2} {u}_{i - 1} ) ,$$

where uₕ₊₁ is the special symbol indicating the end of the sentence.

With an accent class n-gram model, the probability of a word sequence in Equation (1) is calculated by multiplication of the class n-gram probability and the probability of each word in the class, which may be expressed as:

$${P}_{c} ( {u}_{1} {u}_{2} … {u}_{h} ) = {\sum }_{i = 1}^{h + 1} P ( {u}_{i} \vert c ( {U}_{i} ) ) P ( c ( {u}_{i} ) \vert c ( {u}_{i - k} ) … c ( {u}_{i - 2} ) c ( {u}_{i - 1} ) ) ,$$

where c(u) is a class that contains a set of word u. The probability of u in c is calculated by counting words u in the training corpus:

$$P ( u \vert c ( ( u ) ) = \{ \begin{matrix}α \frac{N ( u , c ( u ) )}{\begin{matrix}\sum {u}^{′} , N ( {u}^{′} , c ( {u}^{′} ) ) \neq \\ 0 N ( {u}^{′} , c ( {u}^{′} ) )\end{matrix}} , & if N ( u , c ( u ) ) \neq 0 \\ ( 1 - α ) \frac{1}{\sum {u}^{′} , N ( {u}^{′} , c ( {u}^{′} ) ) = {0}^{1}} & otherwise\end{matrix} \\ where 0 \leq α \leq 1.$$

In this equation, the probability for each word u that is found in the corpus is calculated based on the count N(u, c(u)) which is the number of times the word is found in the training corpus. Meanwhile, a small value is given for the probabilities of the words not found in the corpus. Those words are the words of the dictionary words and the words generated by assuming context accents. The parameter a is a predefined coefficient to spare low probabilities for the words not found in the corpus.

Exemplary embodiments leverage the accurate accent estimation of the word n-gram model and the wide coverage of the class n-gram model, by using an interpolation technique. An interpolation technique is a method of combining various models. Exemplary embodiments use a linear interpolation that can make use of component models which are made by different estimating methods. According to an exemplary embodiment, the probability of the word sequence in Equation (1) is calculated by:

P(u₁u₂ . . . uₕ)=λᵤPᵤ(u₁u₂ . . . uₕ)+λ_{c}P_{c}(u₁u₂ . . . uₕ).

where 0≦{λᵤ, λ_{c}}≦1, λᵤ+λ_{c}=1.
The interpolation coefficients λᵤ, and λ_{c} are estimated using the training corpus.

Thus, in order to produce output 316, when TTS 320 receives input 306, which is comprised of a set of one or more characters, wherein each character represents a set one or more words, sequencer 304 analyzes each word in the set of words for each character in the set of characters using a word n-gram model. Thus, the characters that comprise input 306 are converted into the individual words that make up each character. Sequencer 304 generates a list of words for each word in the set of words for each character in the set of characters based on the word n-gram model. Each word in the list of words is a predicted word for a word in the set of words for each character in the set of characters, based on the word n-gram model. In other words, sequencer 304 generates a list of words that comprise all the possible words that could be a particular word in a set of words, based on the word n-gram model. For example, if the input was the sentence “I read a book” then, for the term “I.”, a list comprising the terms “I/noun”, “I/verb”, “I/article” and “I/adjective” would be generated based on a word n-gram model when taking into consideration the set of possible spellings, the phonemes and the parts of speech. Sequencer 304 does this for each word in the set of words for each character in the set of characters. Sequencer 304 assigns a score to each word in the list of words for each set of words for each character in the set of characters. The score is based on the likelihood the word is the correct word for a word in the set of words, based on the word n-gram model.

Sequencer 304 also analyzes each word in the set of words for each character in the set of characters using an accent class n-gram model. As was done for the word n-gram model, sequencer 304 generates a list of words for each word in the set of words for each character in the set of characters based on the accent class n-gram model. Each word in the list of words is a predicted word for a word in the set of words for each character in the set of characters, based on the accent class n-gram model. In other words, sequencer 304 generates a list of words that comprise all the possible words that could be a particular word in a set of words, based on the accent class n-gram model. For example, if the input set of words were the sentence “I read a book,” the list of words for “I,” according to the accent class n-gram model, would be “I/ai/0” and “I/ai/1”. For “read’ the list would be “read/ri:d/0” and read/ri:d/1″. Zero (0) and one (1) represent the accent. An accent is the word prominence or strength of emphasis. Thus “1” represents the word most strongly emphasized. Sequencer 304 does this for each word in the set of words for each character in the set of characters. Sequencer 304 assigns a score to each word in the list of words for each set of words for each character in the set of characters. The score is based on the likelihood the word is the correct word for a word in the set of words, based on the accent class n-gram model.

Sequencer 304 combines the two lists of words for each word in the set of words for each character in the set of characters. However, the ordering of the words in the original sequence must be maintained so that the sequence can be reproduced. Therefore, sequencer 304 combines the lists to form a set of order pairs for each word in the set of words for each character in the set of characters. Sequencer 304 combines, by adding the two scores for each word in the set of ordered pairs, to form a combined score for each word in the set of ordered pairs. This combined score is determined for each word in the set of ordered pairs for each word in the set of words for each character in the set of characters.

Sequencer 304 forms a set of sequences of words. Each sequence of words in the set of sequences of words represents a unique combination of an attribute and an associated word from the set of ordered pairs for each word in the set of words for each character in the set of characters. An attribute represents the position of the word in the sequence. Sequencer 304 calculates a total score for each sequence of words in the set of sequences of words by adding the combined score for each word in the sequence of words together. Sequencer 304 selects a sequence of words from the set of sequences of words having a highest total score, generating output 316, and presents output 316 to a user, such as a waveform generating process. Output 316 is presented to a back-end process, which is a waveform generation process. The waveform generation process generates waveforms using output 316. These generated waveforms are presented to a user as an audio, video, or tactile representation or any combination thereof of the selected sequence of words.

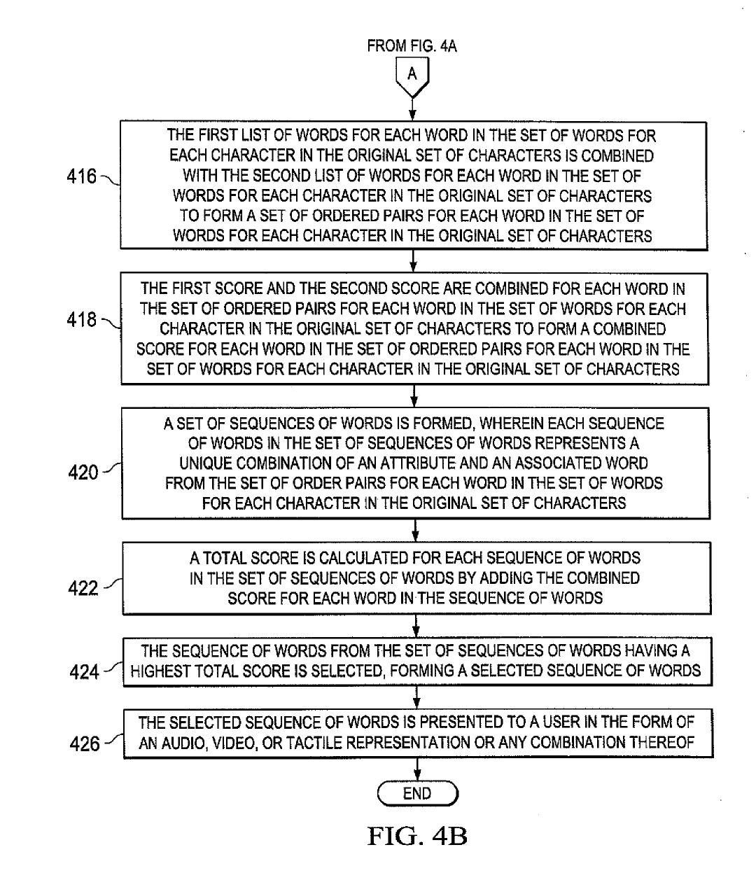

FIGS. 4A-4B show a flowchart illustrating the operation of determining a sequence of words according to an exemplary embodiment. The operation of FIGS. 4A-4B may be performed by sequencer 304 in FIG. 3. The operation begins when an input is received, wherein the input comprises an original set of characters, wherein each character in the original set of characters comprises a set of words (step 402). Each word in the set of words for each character in the original set of characters is analyzed using a first model (step 404). According to an exemplary embodiment, the first model is word n-grain model.

A first list of words for each word in the set of words for each character in the original set of characters is generated using the first model, wherein each word in the first list of words is a predicted word for a word in the set of words for each character in the original set of characters based on the first model (step 406). A first score is assigned to each word in the first list of words, wherein the first score is based upon a likelihood that the word is a correct word for a word in the set of words for each character in the original set of characters based on the first model (step 408). Each word in the set of words for each character in the original set of characters is analyzed using a second model (step 410). According to an exemplary embodiment, the second model is an accent class n-gram model.

A second list of words for each word in the set of words for each character in the original set of characters is generated using the second model, wherein each word in the second list of words is a predicted word for a word in the set of words for each character in the original set of characters based on the second model (step 412). A second score is assigned to each word in the second list of words, wherein the second score is based upon a likelihood that the word is a correct word for a word in the set of words for each character in the original set of characters based on the second model (step 414). The first list of words for each word in the set of words for each character in the original set of characters is combined with the second list of words for each word in the set of words for each character in the original set of characters to form a set of ordered pairs for each word in the set of words for each character in the original set of characters (step 416). The first score and the second score are combined for each word in the set of ordered pairs for each word in the set of words for each character in the original set of characters to form a combined score for each word in the set of ordered pairs for each word in the set of words for each character in the original set of characters (step 418).

A set of sequences of words is formed, wherein each sequence of words in the set of sequences of words represents a unique combination of an attribute and an associated word from the set of order pairs for each word in the set of words for each character in the original set of characters (step 420). A total score is calculated for each sequence of words in the set of sequences of words by adding the combined score for each word in the sequence of words (step 422). The sequence of words from the set of sequences of words having a highest total score is selected, forming a selected sequence of words (step 424). The selected sequence of words is presented to a user in the form of an audio, video, or tactile representation or any combination thereof (step 426) and the operation ends. In an exemplary embodiment, the selected sequence of words is presented to a back-end process, which is a waveform generation process. The waveform generation process generates waveforms using the selected sequence of words. These generated waveforms are presented to a user as an audio, video, or tactile representation or any combination thereof of the selected sequence of words.

Exemplary embodiments provide generating a sequence of words based on input. Exemplary embodiments simultaneously handle word segmentation, part-of-speech tagging, grapheme-to-phoneme conversion, and pitch accent generation when determining a sequence of words. Exemplary embodiments provide advantages including scalability and ease of domain adaptation compared with rule-based approaches. Exemplary embodiments improve the accuracy of the estimation of accents and phonemes by combining the word-based n-gram model and the accent class-based n-gram model.

Thus, exemplary embodiments determine a sequence of words. Exemplary embodiments analyze an input set of words using two models. One model is word n-gram model and the other model is an accent class n-gram model. According to the accent class n-gram model, words with the same accentual feature are grouped into a class. Not only the words found in the training corpus are grouped, but also grouped into these classes are additional words found in the dictionary. With this procedure, the coverage of the model can be made as large as the dictionary, whereas in prior solutions the coverage was limited to the list of words found in the corpus, which is smaller than the dictionary. Therefore, the accent class n-gram model can now be used to predict the accent changes of the word in contexts not found in the training corpus, while the original stochastic model still supports accurate accent estimation for the contexts that are included in the corpus.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer usable or computer readable medium providing program code for use by or in connection with a computer or any instruction execution system. For the purposes of this description, a computer usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. (canceled)

2. A method for selecting a sequence of words for text-to-speech synthesis, the method comprising:
receiving an input comprising a set of words;
determining a first list of potential word types for each of the words in the set of words;
assigning a first score to each potential word type in each list of potential word types based on the likelihood the corresponding word type is correct;
determining a second list of potential word parameters for each of the words in the set of words;
assigning a second score to each potential word parameter in each list of potential word parameters based on the likelihood the corresponding word parameter is correct;
forming a plurality of pairs for each word in the set of words, each pair comprising a unique pair of word type and word parameter from the first list and the second list for the corresponding word;
forming a plurality of word sequences, each word sequence comprising the set of words combined with unique combinations of pairs for each word in the word sequence;
scoring each word sequence by combining the first score and the second score for each pair and summing the combined scores over each unique combination of pairs for each of the plurality of word sequences; and
selecting the word sequence with the highest score as the correct word sequence.

3. The method of claim 2, wherein the potential word types are parts of speech.

4. The method of claim 2, wherein the potential word parameters are accents.

5. The method of claim 2, further comprising performing text-to-speech on the selected word sequence.

6. At least one computer readable storage medium storing instructions that, when executed on at least one processor, performs a method for selecting a sequence of words for text-to-speech synthesis, the method comprising:
receiving an input comprising a set of words;
determining a first list of potential word types for each of the words in the set of words;
assigning a first score to each potential word type in each list of potential word types based on the likelihood the corresponding word type is correct;
determining a second list of potential word parameters for each of the words in the set of words;
assigning a second score to each potential word parameter in each list of potential word parameters based on the likelihood the corresponding word parameter is correct;
forming a plurality of pairs for each word in the set of words, each pair comprising a unique pair of word type and word parameter from the first list and the second list for the corresponding word;
forming a plurality of word sequences, each word sequence comprising the set of words combined with unique combinations of pairs for each word in the word sequence;
scoring each word sequence by combining the first score and the second score for each pair and summing the combined scores over each unique combination of pairs for each of the plurality of word sequences; and
selecting the word sequence with the highest score as the correct word sequence.

7. The least one computer readable storage medium of claim 6, wherein the potential word types are parts of speech.

8. The least one computer readable storage medium of claim 6, wherein the potential word parameters are accents.

9. The least one computer readable storage medium of claim 6, further comprising performing text-to-speech on the selected word sequence.

10. A system for selecting a sequence of words for text-to-speech synthesis, the method comprising:
at least one input for receiving an input comprising a set of words; and
at least one computer configured to determine a first list of potential word types for each of the words in the set of words, assign a first score to each potential word type in each list of potential word types based on the likelihood the corresponding word type is correct, determine a second list of potential word parameters for each of the words in the set of words, assign a second score to each potential word parameter in each list of potential word parameters based on the likelihood the corresponding word parameter is correct, form a plurality of pairs for each word in the set of words, each pair comprising a unique pair of word type and word parameter from the first list and the second list for the corresponding word, form a plurality of word sequences, each word sequence comprising the set of words combined with unique combinations of pairs for each word in the word sequence, score each word sequence by combining the first score and the second score for each pair and summing the combined scores over each unique combination of pairs for each of the plurality of word sequences, and select the word sequence with the highest score as the correct word sequence.

11. The system of claim 10, wherein the potential word types are parts of speech.

12. The system of claim 10, wherein the potential word parameters are accents.

13. The system of claim 10, further comprising performing text-to-speech on the selected word sequence.
